(19) United States
(12) Patent Application Publication
(10) Pub. No.: US 2025/0242570 A1
(43) Pub. Date: Jul. 31, 2025

(54) Hybrid Polymer Adhesive and Laminate Using the Adhesive

(71) Applicant: Custom Laminating Corporation, Mt. Bethel, PA (US)

(72) Inventors: Michael Zajaczkowski, Bellefonte, PA (US); David Berner, Nazareth, PA (US); Brian Shaffer, Easton, PA (US)

(21) Appl. No.: 18/591,307

(22) PCT Filed: Aug. 29, 2022
(86) PCT No.: PCT/US2022/041796

§ 371 Date: Feb. 29, 2024

Related U.S. Application Data
(60) Provisional application No. 63/238,258, filed on Aug. 30, 2021.

(51) Int. Cl. B32B 7/12; B32B 27/06; B32B 27/32; B32B 27/34; B32B 37/12; C09J 175/04

(52) U.S. Cl. CPC B32B 7/12; B32B 27/32; B32B 27/34; C09J 175/04; B32B 27/06; B32B 2037/1269; B32B 2250/02; B32B 2270/00; B32B 2307/51; B32B 2307/5825; B32B 2307/7376; B32B 2323/043; B32B 2323/046; B32B 2377/00

(57) ABSTRACT

A polymer adhesive includes a mixture of polyurethane and polyacrylate polymers, which lead to a miscible hybrid polymer system that displays a single glass transition temperature (Tg). A laminate includes a first substrate, a second substrate, and the polymer adhesive between the first substrate and the second substrate.

### BACKGROUND OF THE INVENTION

### Field of the Invention

The present invention relates to a hybrid polymer adhesive and laminate using the adhesive.

### Description of the Related Art

Both polyurethanes and polyacrylates are useful as adhesives. Both find utility in multiple applications as laminating adhesives and Pressure Sensitive Adhesives (PSAs). Although blends of polyurethanes (PUs) and polyacrylates (PAS) are known to exist, they are characterized as 1) phase separated blends where distinct phases exist either in discreet phases or in core-shell morphologies or 2) as copolymerized grafted polymers. In both cases, these PU-PA systems are typically produced by copolymerizing the polyacrylate in the presence of the PU.

It would be beneficial to provide an adhesive formed by compatible mixture of polyurethane and polyacrylate polymers, which lead to a miscible hybrid polymer system that displays a single glass transition temperature (Tg).

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention is a polymer adhesive comprising a pre-polymerized polyacrylate and a polyurethane.

In another embodiment, the present invention is a laminate that includes a first substrate, a second substrate, and the polymer adhesive between the first substrate and the second substrate.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a graph of a blend of polymers in the ratio from adhesive example 1, with “Parts cross-linker” being a ratio of cross-linker to 100 parts of the solid polymer blend;

FIG. 2 is a Table of Properties of 1.2 mil MTI black/grey polypropylene laminated onto Raven F450WB;

FIG. 3 is a table of break force, elongation at maximum load, and elongation at maximum extension for 1.2 Mil (0.03 mm) MTI Black/Grey Polypropylene Laminated onto Raven F450WB; and

FIG. 3A is a table of break force, elongation at maximum load, and elongation at maximum extension for .004″ (0.1 mm) Black Valeron.

### DETAILED DESCRIPTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

The word “about” is used herein to include a value of +/−10 percent of the numerical value modified by the word “about” and the word “generally” is used herein to mean “without regard to particulars or exceptions.” Unless explicitly stated otherwise, each numerical value and range should be interpreted as being approximate as if the word “about” or “approximately” preceded the value of the value or range.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

The present invention provides a compatible mixture of polyurethane and polyacrylate polymers, which lead to a miscible hybrid polymer system that displays a single glass transition temperature (Tg). This hybrid system can be produced by a simple blending technique and has particular utility as a laminating adhesive. Not only is the inventive system advantageous to lower the cost of the polyurethane system by blending the polyurethane with a lower cost polyacrylate, adhesion to polyolefin films is enhanced as well elongation properties of the olefin laminates produced.

The present invention is a blend of a pre-polymerized polyacrylate (PA) and polyurethane (PU) polymers. A crosslinker is added to the blend to enhance properties. The PA-PU displays adhesive properties with excellent adhesion to olefin substrates. The PA-PU is particularly useful for laminating a Polyester Film to a polyolefin film or a bonding two polyolefin films.

An exemplary PA, PU, and crosslinker, along with exemplary laminate layers, is provided below in Table 1.

TABLE 1

| Material | Description |
|---|---|
| E5721 | Pressure sensitive acrylic emulsion |
| | polymer supplied by Avery Dennison at |
| | 59% solids with a reported Glass |
| | Transition of −48° C. |
| L3941 | An aliphatic Polyurethane dispersion at |
| | 35% solids supplied by the C. L |
| | Hauthaway & Son Corporation. |
| Bayhydur ® XP 2547 | Hydrophilic aliphatic polyisocyanate |
| | based on hexamethylene diisocyanate |
| | supplied by Covestro (cross-linker) |
| Desmodur N3900 | A low-viscosity, aliphatic polyisocyanate |
| | resin based on hexamethylene |
| | diisocyanate (HDI) supplied by |
| | Covestro (cross-linker) |
| Dynasylan ®AMEO | A bifunctional silane possessing a |
| | reactive primary amino group and |
| | hydrolyzable ethoxysilyl groups |
| | supplied by Evonik |
| AQUIS - KW 3720 | A carbon black liquid pigment |
| | preparation based on nonionic and |
| | anionic wetting and dispersing agent |
| | supplied by Heubach |
| WB450 | An HDPE^{†}/LDPE^{††} olefin blend .0045″ |
| | thick film from Raven Industries |
| 3 Ply Film: two | .0012″(.03 mm) thick 3 layer film |
| polypropylene layers with | supplied by MTI Polyexe Inc. |
| a LLDPE^{†††} core between | |
| Heat Seal film | .0005 inch (.013 mm) thick |
| | polyethylene film with a polyethylene |
| | acrylic acid bonding layer on one side |
| | provided by Mondi |

^{†}= High density polyethylene
^{††}= Low density polyethylene
^{†††}= Linear low density polyethylene

### Example 1

### Adhesive Formulation 1:

E5721-73 pounds (33.12 Kgs)
L3941-123 pounds (55.84 Kgs)
XP 2547-4 pounds (1.82 Kgs)

The above formulation was mixed with mild agitation and coated with a gravure cylinder onto a moving web of a .0045″ inch (0.11 mm) thick olefin film (WB450) and dried in a 4-zone infrared oven with zone temperatures of 115° F. (46° F.), 125° F. (52° C.), 125° F. (52° C.), and 125° F. (52° C.) (the multiple 125° F. (52° C.), temperatures are used to maintain film integrity). The dried adhesive basis weight was 4.9-5.3 pounds per ream (2.22-2.41 Kgs per 279 square meters). The dried adhesive coated WB450 was laminated to the 3 Ply MTI film by passing both layers through a nip consisting of a rubber roll and a stainless steel roll. The laminating pressure was 65 PSA (448,175 Pascals) and the stainless steel roll temperature was 250° F. (121° C.).

### Test Results.

T-peel testing was done according to ASTM D1876-08, Standard Method for Peel Resistance of Adhesives, with a Mark-10 Model M5-20 force gauge at a speed of 3 in/min (76 mm/min). Average force in pounds and kilograms is reported.

ASTM D1938-19-Standard Test Method for Tear-Propagation Resistance (Trouser Tear) of Plastic Film and Thin Sheeting by a Single-Tear Method. This test method covers the determination of the force necessary to propagate a tear in plastic film and thin sheeting (thickness of 1 mm (0.04 in.) or less) by a single-tear method. The method is not applicable for film or sheeting material where brittle failures occur during testing.

### Experimental Conditions:

Grip separation of 2″ (50.8 mm); and
10″/minute (254 mm/minute) test speed.

Recorded maximum tear force (Newtons) and extension at maximum force (millimeters).

ASTM 1004-13—Standard Test Method for Tear Resistance (Graves Tear) of Plastic Film and Sheeting. This test method covers the determination of the tear resistance of flexible plastic film and sheeting at very low rates of loading, 51 mm (2 in.)/min. and is designed to measure the force to initiate tearing.

### Experimental Conditions:

Grip separation of 1″ (25.4 mm); and
2″/minute (50.8 mm/minute) test speed.

Recorded maximum tear force (Newtons) and extension at maximum force (millimeters).

ASTM D1000-10 section 123-Standard Test Methods for Pressure-Sensitive Adhesive-Coated Tapes Used for Electrical and Electronic Applications. Puncture resistance is a test to measure the resistance of a tape to puncture by a rounded probe. Puncture resistance is important because of the possibility that objects with irregular surfaces or relatively sharp contours (such as wire or laminate) will be present in the application and have the potential to cause a rupture in the tape.

### Experimental Conditions:

2″/minute (50.8 mm/minute) test speed; and
Maximum puncture force (lbF and Newtons) was recorded.

ASTM D638 Tensile and Elongation (modified for sample width and pull rate)—ASTM D638 is performed by applying a tensile force to a sample specimen and measuring various properties of the specimen under stress. It is conducted on a universal testing machine (also called a tensile testing machine) at tensile rates ranging from 1 to 500 mm/min until the specimen fails (yields or breaks).

### Experimental Conditions:

1″ (25.4 mm) width samples [2″ (50.8) width would elongate to the maximum length and never break];
Grip separation of 1″ (25.4 mm);
20″/minute (508 mm/minate) test speed; and
Recorded lbf at break, elongation at break (inches and mms), and elongation at maximum extension (inches and mms).

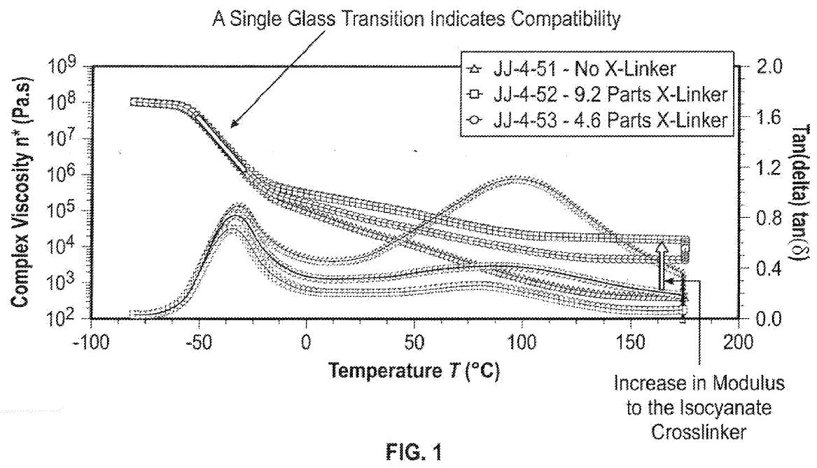

Dynamic Mechanical Analysis (DMA)—DMA was performed on cured adhesives (FIG. 1). The blended formulation was found to have a single Glass Transition Temperature (Tg). The effectiveness the Isocyanate crosslinker was evidenced by the increase in modulus with increasing crosslinker. Regarding polymer compatibility, if the polymer pair are miscible, forming one phase, then one glass transition temperature will be observed. If the polymers are totally immiscible, then two glass transitions will be observed at the glass transitions of the homopolymers.

### DMA Procedure—Sample Preparation

### Adhesive Films

Coatings of ˜4-5 mil (˜. 1-. 13 mm) were made with a drawdown bar onto polypropylene film;
Films were dried at 75° C. for 1.5 h (conditions for lot A034KR008 may differ); and
A ball of adhesive (˜0.14 g) was made from the dry adhesive film.

### Rheology

Instrument-Discovery Hybrid 2 rheometer from TA Instruments;
8 mm parallel plates, disposable aluminum;
Approx. 2 mm gap;
Oscillation Temperature Ramp: −80° C. to 175° C. at 3° C./min;
0.05% strain, 1 Hz;
Sample was loaded at 90° C. to allow for good adhesion to plates and shaping before method was started; some samples required trimming.

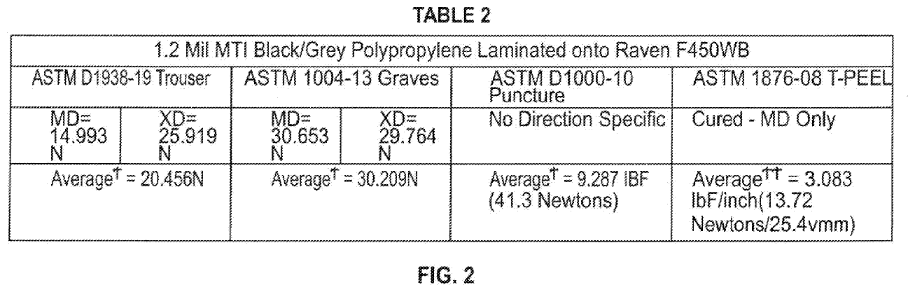

The results are provided in Table 2 (FIG. 2), wherein:
MD-Machine Direction
XD-Cross Direction
Cured T-peel bonds measured>72 hours after lamination
†=Average of 10
††=Average of 9
Tensile Strength [2 inch (50.8 mm) wide strip]=No failure at >1000% Elongation
Tensile
Strength [1 inch (25.4 mm) wide strip]=24.5 pounds (109 Newtons) at greater than 700% elongation.

FIG. 1 shows a graph of complex viscosity (Complex Modulus divided by Angular Frequency) vs. temperature (upper points) and Tan (θ) (Ratio of Loss Modulus to Storage Modulus) (lower points) for the inventive adhesive. A single glass transition between about −60° C. and about −35° C. indicates compatibility between the PA-PU polymers, both with and without cross-linkers.

### High Strength and High Elongation Laminates.

Laminates of two or more layers have been produced with enhanced tensile, elongation, puncture and tear resistance. These laminates find utility in the building and construction industries as roofing and waterproofing membranes, packaging, and as print media. One layer is a Polyolefin film with enhanced puncture and tear resistance and the other layer is chosen from olefins, polyesters, and polyurethanes, polypropylene, PVC, nylon, vinyl, nonwovens, additives for UV resistance for outdoor applications. The olefins used can be LDPE, HDPE, LLDPE, HDPE and LDPE blends, and orientated versions of these materials. The layers are bonded to each other with an adhesive. Typical values would be:
Tensile strength >20 Pounds per inch (89 Newtons/25.4 mm) width with 500% elongation without delamination;
Tear resistance (Graves)>25 Newtons;
Tear resistance (Trouser)>15 Newtons (MD) and 22 Newtons (XD); and
Puncture resistance >6 lbf (27.24 Newtons).

TABLE 3

| Material | Description |
|---|---|
| .6 Mil Nylon Laminated | .0006 inch (.015 mm) nylon film |
| | supplied by Americam Biaxis Inc. |
| .48 Mil Polyester | .00048 inch (.012) thick Polyester film |
| | supplied by Polyplex |
| .92 Mil Polyester | .00092 inch (.023 mm) thick Polyester |
| | film supplied by Polyplex |
| F450WB | An HDPE^{†}/LDPE^{††} olefin blend .0045″ |
| | (.11 mm) thick film from Raven |
| | Industries |
| 3 Ply Film: two | .0012″ (.03 mm) thick 3 layer film |
| polypropylene layers with | supplied by MTI Polyexe Inc. |
| a LLDPE^{†††} core between | |

^{†}= High density polyethylene
^{††}= Low density polyethylene
^{†††}= Linear low density polyethylene

### Example 2. Samples Produced Similarly to Example 1

TABLE 4
Master Roll 1 - White side of Raven F450WB [4.5 mil (.11 mm)] & Black
Side of MTI Black/Grey Polypropylene [1.2 mil (.03 mm)]

| | | Tensile 1 inch | ASTM D1938-19 | ASTM 100413 | ASTM D1000-10 |
|---|---|---|---|---|---|
| Gauge | Weight | (25.4 mm) width | Trouser Tear | Graves Tear | Puncture |
| 0.00624 in | 92.13 | MD = 23.455 | MD = 18.377 N | MD = 29.026 N | Not Direction |
| 0.158 mm | lb/ream | lbF = 104.3 N | XD = 26.07 N | XD = 29.240 N | Specific |
| | 42 Kg/279 sq. m | XD = 25.608 | | | |
| | | lbF = 116.3 N | | | |

| N/A | Average = 24.532 | Average = 22.222 N | Average = 29.13 N | Average = 7.899 |
|---|---|---|---|---|
| | lbF = 111.4 N | | | lbF = 35.15 N |

### Example 3. Samples Produced Similarly to Example 1

TABLE 5

| | .0006″ (.015 mm) Nylon Laminated onto F450WB | | | | | | | |
|---|---|---|---|---|---|---|---|---|
| | ASTM D1938-19 (Trouser Tear) | | | | ASTM D1004-13 (Graves Tear) | | | |
| | Break (N) | | Elongation (mm) | | Break (N) | | Elongation (mm) | |
| Test # | MD | XD | MD | XD | MD | XD | MD | XD |
| 1 | 14.114 | 21.108 | 55.906 | 56.349 | 28.238 | 29.012 | 13.418 | 21.515 |
| 2 | 15.971 | 22.305 | 54.733 | 60.673 | 26.689 | 27.594 | 12.757 | 19.234 |
| 3 | 15.449 | 22.341 | 55.010 | 58.887 | 28.742 | 28.019 | 13.639 | 20.650 |
| 4 | 13.351 | 22.644 | 52.454 | 56.184 | 29.521 | 27.163 | 14.186 | 20.168 |
| 5 | 18.155 | 22.539 | 53.723 | 59.043 | 28.809 | 26.789 | 14.613 | 24.074 |
| avg. | 15.408 | 22.187 | 54.365 | 58.227 | 28.400 | 27.715 | 13.723 | 21.128 |
| MD + XD | 18.798 | | 56.296 | | 28.058 | | 17.425 | |
| Avg. | | | | | | | | |

### Example 4. Samples Produced Similarly to Example 1

TABLE 6

| | .00048″ (.012 mm) Polyester Laminated onto F450WB | | | | | | | |
|---|---|---|---|---|---|---|---|---|
| | ASTM D1938-19 (Trouser Tear) | | | | ASTM D1004-13 (Graves Tear) | | | |
| | Break (N) | | Elongation (mm) | | Break (N) | | Elongation (mm) | |
| Test # | MD | XD | MD | XD | MD | XD | MD | XD |
| 1 | 15.384 | 20.462 | 55.774 | 58.883 | 25.701 | 28.085 | 2.786 | 13.726 |
| 2 | 18.103 | 23.327 | 56.292 | 61.890 | 26.062 | 28.568 | 19.242 | 22.033 |
| 3 | 13.901 | 20.549 | 58.145 | 58.801 | 25.399 | 29.333 | 11.380 | 13.945 |
| 4 | 16.439 | 22.793 | 53.677 | 61.869 | 24.908 | 29.078 | 11.851 | 13.620 |
| 5 | 14.178 | 19.113 | 54.307 | 60.304 | 25.973 | 28.362 | 12.719 | 13.668 |
| avg. | 15.601 | 21.249 | 55.639 | 60.349 | 25.609 | 28.685 | 11.596 | 15.398 |
| MD + XD | 18.425 | | 57.994 | | 27.147 | | 13.497 | |
| Avg. | | | | | | | | |

### Example 5. Samples Produced Similarly to Example 1

TABLE 7
Tensile and elongation from Example 1 vs commercially available material.

| | .00092″ (.023 mm) Polyester Laminated onto F450WB | | | | | | | |
|---|---|---|---|---|---|---|---|---|
| | ASTM D1938-19 (Trouser Tear) | | | | ASTM D1004-13 (Graves Tear) | | | |
| | Break (N) | | Elongation (mm) | | Break (N) | | Elongation (mm) | |
| Test # | MD | XD | MD | XD | MD | XD | MD | XD |
| 1 | 19.458 | 18.326 | 56.164 | 55.749 | 30.851 | 31.824 | 2.603 | 1.906 |
| 2 | 14.389 | 16.164 | 54.112 | 53.986 | 30.954 | 33.212 | 2.790 | 2.571 |
| 3 | 15.973 | 16.975 | 53.017 | 57.443 | 30.024 | 32.816 | 2.599 | 2.656 |
| 4 | 18.058 | 16.959 | 53.885 | 56.627 | 31.152 | 31.945 | 2.768 | 2.253 |
| 5 | 19.486 | 15.670 | 54.605 | 53.164 | 38.817 | 29.101 | 2.753 | 2.346 |
| avg. | 17.473 | 16.819 | 54.357 | 55.394 | 32.360 | 31.780 | 2.703 | 2.346 |
| MD + XD | 17.146 | | 54.875 | | 32.070 | | 2.524 | |
| Avg. | | | | | | | | |

### Table 7. Tensile Procedure:

1″ (25.4 mm) Wide samples;
1″ (25.4 mm) Grip separation; and
20″/minute (508 mm/minute) jaw separation speed.

Data Recorded: lbf and N at break, elongation at break (inches and mm), and elongation at maximum extension (inches and mm).

Results: The elongation at break is 280% more than the competitive material.

### Example 6

### Adhesive from Example 2

34.7 grams E5721
58.5 grams L3941
3.7 grams Desmodur N3900
3.1 grams KW3720

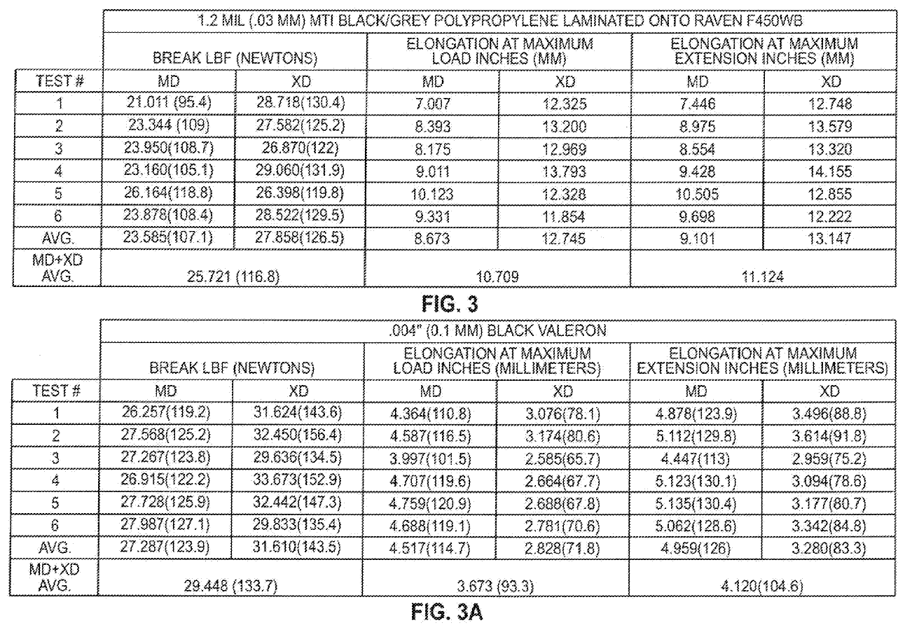

FIGS. 3 and 3A provide tables of break force, elongation at maximum load, and elongation at maximum extension for 1.2 Mil (0.03 mm) MTI Black/Grey Polypropylene Laminated onto Raven F450WB and .004″ (0.1 mm) Black Valeron, respectively.

### Multi-Layer Laminate—First Two Layers:

The above formulation was mixed with mild agitation and coated with a mayer rod onto .0029 inch (0.07 mm) thick aluminum foil and dried in an oven at 75° C. for 5 minutes prior to lamination. The dried adhesive had an applied coat weight of 3.9 lbs/ream (1.78 Kgs/279 square meters). The adhesive coated aluminum was laminated to a corona treated .92 Mil (0.023 mm) Polyester film by passing the films though a Cheminstruments HL-100 laminator with a rubber and a heated steel roll. The laminating conditions were 121° C. steel roll temperature, a speed of 250 inches/minute, and a laminating pressure of 70 PSI (482,650 Pascals).

The same adhesive used on the first two layers was coated onto the polyester side of laminate produced above and dried in an oven at 75° C. for 5 minutes prior to lamination. The dried adhesive had an applied coat weight of 3.9 lbs/ream (1.77 Kg/279 square meters). The same laminating conditions described above were used to bond a .0005 inch (0.013 mm) thick polyethylene film with a polyethylene-acrylic acid heat sealable layer. The aluminum-polyester layers were bonded to the non-heat sealable side of the polyethylene film preserving the heat sealable layer for further bonding. The final multilayer laminate consisted of the following layers: .0029 inch (0.074 mm) aluminum foil/.92 mil (0.023 mm) polyester/.0005 inch (0.013 mm) polyethylene w/heat seal layer. The pull test results, in PSI and Pascals) for this laminate are in Table 8 below.

TABLE 8
Aluminum foil/polyester/polyethylene w/heat seal layer laminate

| t-peel AL | | Machine | Cross |
|---|---|---|---|
| foil/polyester | t-peel | Direction | Direction |
| layer | polyester/polyethylene | Tensile | Tensile |
| PLI (Pascals) | layer PLI (Pascals) | PLI (Pascals) | PLI (Pascals) |
| 1.683 (11,604) | 1.9(131,005), | 54.4 (375,088) | 53.5 (368,883) |
| | polyethylene film tear^{†} | [22%^{††}] | [18%^{††}] |
| 1.982 (13,666) | 2.0(13,790), | 53.4(368,193) | 54.8(377,846) |
| | polyethylene film tear^{†} | [18%^{††}] | [23.5%^{††}] |
| 1.717 (11,839) | 2.0(13,790), | 52.2(359,919) | 54.4(375,088) |
| | polyethylene film tear^{†} | [19%^{††}] | [26%^{††}] |

^{†}= bond strength between the polyester and polyethylene layers was greater than the strength of the polyethylene film.
^{††}= elongation at break

The above example demonstrates the adhesive's ability to bond dissimilar materials.

It will be further understood that various changes in the details, materials, and arrangements of the parts which have been described and illustrated in order to explain the nature of this invention may be made by those skilled in the art without departing from the scope of the invention as expressed in the following claims.

What is claimed is:

1. A laminate comprising:
a first substrate;
a second substrate; and
a polymer adhesive between the first substrate and the second substrate, the polymer adhesive comprising a miscible blend of:
a pre-polymerized polyacrylate;
a polyurethane; and
a cross-linker.

2. The laminate according to claim 1, wherein:
the first substrate comprises nylon 0.0006″ (0.015 mm) thick;
the second substrate comprises an HDPE/LDPE olefin blend .0045″ (0.114 mm) thick; and
has an average break force of about 15.4 N in a machine direction and about 22.2 N in a cross direction in a trouser tear test according to ASTM D1938-19.

3. The laminate according to claim 2, wherein the laminate has an average elongation of about 54.4 mm in a machine direction and about 58.2 mm in a cross direction in a pull test according to ASTM D1938-19.

4. The laminate according to claim 1, wherein:
the first substrate comprises polyester 0.0048″ (0.122 mm) thick;
the second substrate comprises an HDPE/LDPE olefin blend .0045″ (0.114 mm) thick; and
has an average break force of about 15.6 N in a machine direction and about 21.2 N in a cross direction in a trouser tear test according to ASTM D1938-19.

5. The laminate according to claim 4, wherein the laminate has an average elongation of about 55.6 mm in a machine direction and about 60.3 mm in a cross direction in a pull test according to ASTM D1938-19.

6. The laminate according to claim 1, wherein:
the first substrate comprises polyester 0.0092″ (0.234 mm) thick;
the second substrate comprises an HDPE/LDPE olefin blend .0045″ (0.114 mm) thick; and
has an average break force of about 17.4 N in a machine direction and about 16.8 N in a cross direction in a trouser tear test according to ASTM D1938-19.

7. The laminate according to claim 6, wherein the laminate has an average elongation of about 54.4 mm in a machine direction and about 55.4 mm in a cross direction in a pull test according to ASTM D1938-19.

8. The laminate according to claim 1, wherein the adhesive has a single glass transition between about −60° C. and about −35° C.

9. The laminate according to claim 1, wherein:
the polyacrylate comprises 73 parts;
the polyurethane comprises 123 parts; and
the cross-linker comprises 4 parts.

10. The laminate according to claim 9, wherein cross-linker comprises an isocyanate.

11. The laminate according to claim 1, wherein the adhesive has a single glass transition between about −60° C. and about −35° C.

12. The laminate according to claim 1, wherein:
the polyacrylate comprises 34.7 parts;
the polyurethane comprises 58.5 parts; and
the cross-linker comprises at least 3.7 parts.

13. The laminate according to claim 12, wherein the cross-linker comprises 9.2 parts.

14. The laminate according to claim 12, wherein the cross-linker comprises 4.6 parts.

15. The laminate according to claim 1, wherein the adhesive has a single glass transition between about −60° C. and about −35° C.

16. The laminate according to claim 1, wherein the laminate has an average break force of greater than about 18 N in a machine direction and about 26.1 N in a cross direction in a trouser tear test according to ASTM D1938-19.

17. The laminate according to claim 1, wherein the laminate has an average puncture strength of greater than about 5 lbF (34475 Pascals) in a puncture test according to ASTM D1000-10.

18. The laminate according to claim 1, wherein the laminate has an average tensile strength of greater than about 15 lbF (103,425 Pascals).
